(19) United States
(12) Patent Application Publication
(10) Pub. No.: US 2012/0024302 A1
(43) Pub. Date: Feb. 2, 2012

(54) Filter for a smoking article

(76) Inventor: John Richardson, London (GB)

(21) Appl. No.: 13/127,525

(22) PCT Filed: Oct. 14, 2009
(86) PCT No.: PCT/EP2009/063398

§ 371 Date: Oct. 25, 2011

(30) Foreign Application Priority Data
Nov. 5, 2008 (GB) 0820229.3

(51) Int. Cl. A24B 15/30; B31C 99/00

(52) U.S. Cl. 131/275; 131/335; 493/39

(57) ABSTRACT

A filter for a smoking article such as a cigarette is provided comprising a body of smoke filtering material (1) and having a thread (5) incorporated therein. The thread is composed of material derived from a plant containing a naturally occurring tobacco flavorant.

### FIELD OF THE INVENTION

The present invention relates to a filter for a smoking article such as a cigarette.

### BACKGROUND

The main function of smoking article filters is to remove some of the substances produced by combustion of the smokable material from the smoke flow as it is drawn by the smoker. Various types of filter constructions have been described.

As well as removing material from the gaseous flow drawn by the smoker, the filter may also be arranged to impart selected substances into the smoke for the purpose of modifying various characteristics. For example, filtration of smoke is generally thought to have a negative effect on the flavour and taste characteristics of the smoke and smoking article filters have been described that are arranged to impart flavourants into the smoke flow.

Menthol is used as a flavourant in a variety of products and is a popular flavourant for use in cigarettes, pipe tobacco, chewing tobacco, and other smoking materials. Menthol produces a cooling sensation when inhaled or consumed and is used extensively because of the refreshing cooling effect it imparts to tobacco smoke.

However, menthol has a high degree of volatility at room temperature, and this makes the menthol concentration difficult to control. It also poses problems in the packaging and handling of the smoking articles. Furthermore, smoking products containing menthol frequently have a short shelf life due to loss of menthol from the product during storage.

To overcome this problem, menthol derivatives or similar compounds that release menthol or menthol-like flavourants have been developed. However, such derivatives may suffer from one or more drawbacks. For example, they may not yield a sufficient quantity of free menthol upon use of the smoking article, they may be unstable or difficult to process, or the pyrolysis or hydrolysis products may be toxic, or may result in an unacceptable taste.

Smoking article filters have been described in which the smoke becomes flavoured as it is drawn due to the filter material having a flavouring agent such as menthol applied uniformly upon it. However, this means of flavouring the smoke has drawbacks including inconsistency of flavour provision, and complications during the manufacturing process, in particular, when one flavourant is exchanged for another.

To overcome this problem, smoking articles have been described in which a flavoured element is introduced into the filter, for example, menthol adsorbed on a support such as diatomaceous earth, from which the menthol is later released. However, it has often been the case that the flavoured element is not introduced in the correct amount or correct position to provide the optimal effect on the smoke. Generally such methods suffer from low menthol yields, and may result in unacceptable taste or appearance of the smoking product.

A modification to the approach of using a flavoured element is described in US 2005/0255978 which discloses an apparatus for manufacturing smoking article filters which have a thread loaded with flavourant passing along the central axis. In this way, greater control may be exerted over the position and amount of flavourant that is incorporated. The preferred material for the manufacture of the thread is cotton, although other materials such as cellulose acetate and rayon may also be used. Cotton thread has drawbacks as a material for providing flavourant, for example becoming discloured and unsightly during consumption of the smoking article. To overcome this problem the cotton may be dyed, however, dyes do not generally have regulatory approval, and may also leach into the surrounding filter material.

### SUMMARY OF THE INVENTION

According to the present invention there is provided a filter for a smoking article, wherein said filter comprises at least one thread composed of material derived from a plant containing a naturally occurring tobacco flavourant.

The plant may be a member of the order Lamiales, which includes plants such as mint, lavender, lilac, olive, and jasmine. More specifically, the plant may be a member of the family Lamiaceae, which is also known as the family Labiatae, or the mint family, and includes many aromatic herbs such as basil, mint, rosemary, sage, savory, marjoram, oregano, thyme, lavender, and perilla. In particular, the plant may be of the genus Mentha, and may be of the species Mentha arvensis.

Threads composed from plant material such as this can have the added advantage of being naturally coloured. Consequently, the thread may be easily distinguished from the remainder of the filter material, giving the filter an interesting and attractive appearance, and making any discolouration of the thread or filter material less obvious.

To provide the desired level of flavour to the smoke, the thread may further comprise additional flavourant. Alternatively or additionally, flavourant may be added to the remaining filter material.

The thread may be between 0.2 mm and 5 mm in diameter, preferably between 0.4 mm and 3 mm in diameter, more preferably between 0.5 mm and 1.5 mm in diameter, and most preferably between 0.7 mm and 1 mm in diameter.

The invention also includes a method of making a filter for a smoking article. The method may involve inserting a thread comprising material from a plant containing a naturally occurring tobacco flavourant into a filter rod. The thread may be inserted into substantially the central cylindrical axis of the filter rod.

As used herein, the term “smoking article” includes smokable products such as cigarettes, cigars and cigarillos whether based on tobacco, tobacco derivatives, expanded tobacco, reconstituted tobacco or tobacco substitutes and also heat-not-burn products.

As used herein, the terms “flavour” and “flavourant” refer to materials which may be used to create a desired taste or aroma in a product.

### BRIEF DESCRIPTION OF THE DRAWINGS

For a fuller understanding of the invention, reference is made to the single FIGURE of the accompanying drawing which illustrates an embodiment of a filter given by way of example, of a filter cigarette.

### DETAILED DESCRIPTION

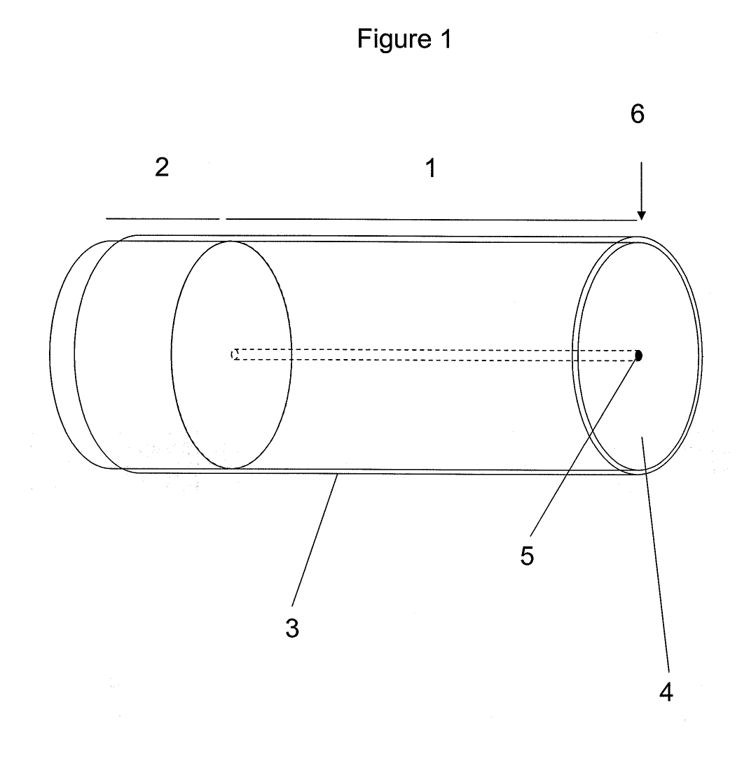

FIG. 1 shows a filter cigarette comprising a filter 1 and a tobacco rod 2. Both the filter 1 and tobacco rod 2 are substantially cylindrical, being generally circular in cross-section, and have diameters which are of a similar size. A layer of tipping paper 3 is wrapped around the cigarette and holds the tobacco rod 2 and the filter 1 together in a longitudinally abutting relationship.

The filter is primarily composed from fibrous cellulose acetate filter material 4 encompassed by a layer of plugwrap (not shown) in a manner well known per se. Located within the filter material is a thin thread 5 which is manufactured from material derived from a plant of the species Mentha arvensis, a type of mint. The thread 5 is situated substantially in the diametric centre of the filter and extends from the mouth end 6 of the filter to the tobacco rod 2 in a generally linear configuration.

In use, negative pressure created by the user sucking on the mouth end 6 of the filter has the effect of drawing smoke along the tobacco rod 2 and through the filter 1. As smoke passes through the filter 1, particulate components of the smoke are retained by the cellulose acetate fibres, at least to some extent. Concurrently with the removal of particulate components, however, flavourants diffuse from the thread 5, into the flow of smoke, and are thus sucked into the mouth of the user.

One method of introducing the thread 5 into the filter 1 is as follows. The filter 1 is manufactured using a process in which a supply of filter material is continuously advanced, the advancing material being continuously condensed to rod form, and the resulting rod being continuously cleaved into individual lengths. Incorporation of the thread 5 occurs as the continuous thread is directed into the centre of the filter material as or before its condensation to rod form. As a result the thread becomes incorporated in the body of the filter rod and extends continuously longitudinally thereof.

The amount of flavourant provided to the smoke by the thread is dependent on a number of factors including the thickness of the thread, the fine structure and the moisture content, and the concentration of flavourant in the plant matter chosen as the raw material.

The thread need not be located at the diametric centre of the filter, and so may be off-centre, and may even be situated substantially towards the circumferential edge of the filter. Two or more threads can be incorporated within the filter, for example between 2 and 20 threads, preferably between 3 and 15 threads, more preferably between 4 and 10 threads.

The thread may have additional flavourants entrained within for the purpose of enhancing or modifying the natural flavour provided by the plant material. In the case of a filter containing multiple threads, the threads within a filter may comprise the same or different flavourants. In some embodiments, the thread may be treated with a colourant prior to its incorporation into the filter for example, for the purpose of providing an interesting and attractive appearance to the mouth end 6 of the filter, to provide flavour identification (such as different colours for different flavours), or to mask any discolouration of the thread or filter material.

When colourants and/or flavourants are added to the thread, these agents are preferably applied to the or each thread immediately before the thread is incorporated in the filter material, for example, by directing the thread through a solution of the agent and then into the filter material as it is condensed. The solvent for the agent is chosen to be compatible with the filtering material and any other component of the filter product.

The filter 1 may comprise a ventilated filter, for example having a porous or perforated wrapper through which in use, external air is drawn to dilute the smoke drawn through the filter. Diluting air tends to travel along the peripheral region of the filter, so that the thread extending along the filter core, where the smoke concentration is highest, increases the possibility of diffusion of flavourant from the thread most effectively and economically.

The invention also includes further modifications and variations falling within the scope of the claims. For example, although the thread has been described as being made from mint, other suitable plants my be utilised and for example the plant may be a member of the order Lamiales, which includes plants such as mint, lavender, lilac, olive, and jasmine. More specifically, the plant may be a member of the family Lamiaceae, which is also known as the family Labiatae, or the mint family, and includes many aromatic herbs such as basil, mint, rosemary, sage, savory, marjoram, oregano, thyme, lavender, and perilla.

These plants may have beneficial qualities. For example, some of these plants are known to contain compounds which have anti-inflammatory properties.

The filter may be a composite filter comprising a plurality of abutted filter sections, for example at least two, preferably at least three filter sections, provided that at least one of the sections comprises a thread as herein described. Preferably the composite filter comprises a single section incorporating a thread as herein described, this section being preferably located at the mouth end of the filter. The filter sections of the composite filter not containing a thread may comprise one or a combination of cellulose acetate, polypropylene, paper or any other suitable material, and may alternatively or additionally comprise adsorbent material, for example, activated charcoal, a resin material such as amberlite or duolite, and/or catalytic material.

1. A filter for a smoking article, wherein said filter comprises at least one thread composed of plant material containing a naturally occurring tobacco flavorant.

2. The filter according to claim 1, wherein the plant material is from a plant that is a member of the order Lamiales.

3. The filter according to claim 2, wherein the plant is a member of the family Lamiaceae.

4. The filter according to claim 3, wherein the plant is a member of the genus Mentha.

5. The filter according to claim 4, wherein the plant is a member of the species Mentha arvensis.

6. The filter according to claim 1 wherein the filter comprises a filter rod formed from cellulose acetate fibers.

7. The filter according to claim 6, wherein the filter rod has substantially cylindrical shape and the at least one thread extends longitudinally through the filter rod.

8. The filter according to claim 1, wherein the at least one thread further comprises a flavorant.

9. A smoking article comprising a rod of smokable material and the filter according to claim 1.

10. A method for making a filter for a smoking article comprising inserting a thread into a substantially cylindrical filter rod, wherein the thread is composed of plant material containing a naturally occurring tobacco flavorant.

11. The method according to claim 10 wherein the thread is inserted into substantially the central cylindrical axis of the filter rod.
